(19) United States
(12) Patent Application Publication
(10) Pub. No.: US 2002/0095442 A1
(43) Pub. Date: Jul. 18, 2002

(54) Creating community web site

(76) Inventors: Robert S. Hunter, Quincy, IL (US); Kyle M. Trudell, Quincy, IL (US)

Correspondence Address: PHILIP L BATEMAN, P O BOX 1105, DECATUR, IL, 62525

(21) Appl. No.: 10/047,209

(22) Filed: Jan. 14, 2002

Related U.S. Application Data
(60) Provisional application No. 60/261,930, filed on Jan. 16, 2001.

(51) Int. Cl. G06F 15/00

(52) U.S. Cl. 707/513

(57) ABSTRACT

A community Web site is created quickly and inexpensively in a two-step method. The first step is to create a prototype Web site having general content and local content. The second step is to provide a licensed Web site to a community, the licensed Web site sharing the general content with the prototype Web site and having local content that is specific to the community.

### CROSS-REFERENCE TO RELATED APPLICATION

This application claims the benefit of U.S. Provisional Application Serial No. 60/261,930, filed Jan. 16, 2001.

### FIELD OF THE INVENTION

This invention relates to business methods. More particularly, this invention relates to methods for creating Web sites for smaller communities in the United States of America.

### BACKGROUND OF THE INVENTION

The Internet comprises a vast number of computers and computer networks that are interconnected through communication links. The interconnected computers exchange information using various services, including the World Wide Web (“the Web”). The Web service enables a server computer to send graphical pages of information to a remote client computer. The remote client computer can then display the Web pages using a special purpose computer program known as a browser. Each computer and Web page of the Web is uniquely identifiable by a Uniform Resource Locator (“URL”). The Web pages are programmed using a language known as HyperText Markup Language (“HTML”). A request for a particular Web page from a client computer to the server computer is made in a language known as HyperText Transfer Protocol (“HTTP”).

It is now common for commercial enterprises to maintain a site on the Web that can be easily accessed by members of the public. Web sites are also becoming common for communities in the United States. The term “community” is used herein to refer to cities, towns, villages, and other population centers. Maintaining a Web site is beneficial for communities in many ways. For example, a well designed and maintained Web site can provide valuable information to residents and employers, both current and prospective, that helps a community thrive and grow. Designing such a Web site from scratch is a large and expensive undertaking that is feasible only for relatively large communities. Smaller communities, especially those having populations of less than about 50,000, need Web sites, but are typically unable to afford the costs of designing a Web site from scratch.

The smaller communities in the United States are faced with grave economic and social crises resulting from a migration of population and businesses to the larger cities. Yet, many of them offer both a high quality of life and great business advantages for companies to relocate some part or all of their operations to smaller cities. A large scale relocation would not only relieve the economic plight of the smaller cities, but it would also reduce the tremendous pressures on overpopulated cities.

The basic problem is that the smaller cities do not have any affordable way to get their complete stories to the decision makers in the companies that might consider them for part or all of their operations. There may be one or more ways that some people may deem adequate ways to provide a Web site that will serve this purpose at an affordable cost. We consider below the various ways that some people might deem to be practical ways, now available to cities, to provide this service.

The explosive growth of the Web during the mid-1990s gave smaller cities a way out of their dilemma, that is, they could advertise to the entire world their superior features that could attract businesses to them. They could now use the World Wide Web which is cheap to use, and enables a complete statement about a city to be made to the entire world, where it can be seen by everyone 24 hours a day, 365 days a year. Even though several years have elapsed, and despite the great need for a model that meets this need, no vehicle has arrived that will permit the smaller cities to present Web sites that tell their stories in a complete, attractive manner, at a cost that smaller cities can afford. This enormous, unfilled need has given rise to the method of this invention.

The inability of smaller cities to find ready, economic access to the Web is caused by the dearth of professionals who are able to create Web sites of high quality, at low cost, that will tell their story in a compelling manner, and that will attract those interested in locating some or all of a business operation outside larger cities. Smaller cities are already strapped financially. They have insufficient funds to meet their pressing needs. There is little support for spending large amounts to create a Web site when so much already needs to be done.

There are four basic ways in which a smaller city can create a Web site. They are: (1) having the Web sites created entirely by city employees, without outside assistance; (2) having the Web site created by city employees using one of the services that enable a person or business totally without Web site skills to create the city's own Web site; (3) outsourcing the Web site to local individuals who are involved in the creation of Web sites for others; and (4) outsourcing the Web site to one of the companies that specialize in creating Web sites for businesses and other organizations. For the reasons outlined below, none of those methods of creating a creditable Web site is feasible for a smaller city. Even worse, each of them is almost certainly doomed to failure.

The first option is to create a Web site in-house by the city's personnel without assistance. Local governments are not well suited for the operation of their own Web sites. That job requires a staff of highly trained individuals who understand the intricacies of the computer, page layout, site architecture, navigation design, typography, color, imagery, graphic design, HTML, web servers, HTTP protocol, domain names, firewalls, and the many other aspects of Web site creation and operation. In addition, they must have experience in business management, marketing, sales, and finance.

The production of a creditable Web site for a smaller city now requires the understanding of all those skills and aptitudes. Most of their viewers have limited equipment and limited comprehension of the computer and the Web. To produce more sophisticated Web sites at this time would eliminate a large percentage of the viewer audience. This condition will change markedly during the next few years. In the near future, the creation of such a Web site will require even greater skills and technology.

The cost of creating its own Web site is prohibitive if the city wishes to have a site that will be sought and found by those seeking space for expansion in smaller cities. It would take months to assemble the team, plus more months to create a suitable Web site, if the city or county were to produce its own.

The second option is creating a Web site using free services available online. It may be suggested that many ways are available for anyone to create his own Web site at no cost using a template provided by GeoCities or one of the other major Web sites. Suffice it to say, such Web sites are very elemental and totally insufficient to attract anyone, let alone a business executive to look for it and use it as a source of important information on relocating a business.

An economic fact of life about Web sites is that one can create a site at no cost, if it has no business purpose. Or, one can spend a huge amount of money if it is to be a site of high quality that will present the message in a way that will be effective in influencing successful businesses. Finding the essential middle ground, that is, the creation and maintenance of a creditable, suitable Web site that performs its functions at a reasonable cost is an objective that has defied all efforts.

It may seem that the ideal way for a city to create a Web site is to resort to one of the various services offered on line that provide templates and instructions. However, the sites that are created by such services are inadequate in presenting or depicting a community in a realistic, artistic, and satisfying way. They are poorly designed, but have a much more serious problem. These “homemade” sites are not adequately designed to attract those who are looking for a particular service, product, or type of information.

The third option is to outsource the Web site to local site preparers. Even the smallest community has one or more local residents who offer their services in preparing and maintaining Web sites. Unfortunately, countless people have rushed into this vacuum and have held themselves out as capable of creating and maintaining a satisfactory Web site for a business. With very few exceptions, their promises far exceeded their capabilities. Consequently, many small businesses have paid large sums only to receive Web sites of little or no value.

In any smaller city, there are several people who advertise their expertise at creating Web sites. Unfortunately, extensive scrutiny indicates that few, if any, have the skill and experience to provide quality Web sites that will perform adequately. In addition, such people are largely self employed and would have to charge a large amount for such sites, because of their limited capital. Under no circumstances could most of them provide such community Web sites at no cost to the public.

Another reason that local Web site creators in smaller cities cannot be profitable over a period of time is that they face an insurmountable obstacle. That is, the operation of that business demands a variety of exceptional talents that will only work for high wages. To succeed they have to have people who are capable administrators, experienced marketing and sales people, mature financial administrators, as well as people who have designer and user experience, who have a great amount of training and experience in the applicable technologies, plus capable writers and editors. In short, a company with only three or four employees (which is probably the maximum size of this kind of company in a smaller city) cannot possibly have the trained personnel necessary to operate the business efficiently and profitably.

The fourth option for smaller cities to create and operate a Web site designed to attract new businesses to their community is to outsource the Web site to e-commerce site producers. There are numerous large corporations that devote a large part of their personnel and efforts to the creation of web sites for business, that is, for so-called e-commerce. They include such giants as IBM and Anderson Consultants. The staffs of such companies undoubtedly have the training and expertise to produce the most lavish, complicated Web sites. However, their charges are huge. Their idea of a small client is one with 100 or less employees. They are high above the reach of smaller cities.

Even if these companies would perform gratuitously for a smaller city, they would be ill prepared to do so. The Web site for the smaller city must be based on a thorough knowledge both of the needs of businesses looking for new locations and on the conditions that exist in the area of the particular city. Typically, these national concerns are tuned to metropolitan communities, not to the smaller America city, where conditions, attitudes, and objectives are so entirely different from those they know and understand.

There are many other reasons a smaller city cannot successfully create an economic, effective Web site that can compete with other cities in attracting new businesses. These reasons are the result of the nature of city governments and the way they operate. These reasons relegate against the success of a smaller city, with its severely limited resources, in trying to establish and maintain an effective Web site. They exist in differing degrees and importance in different cities, and in any one city at different times, depending on the quality of the leadership and the support of the community. Nine of these reasons are discussed below.

First, even when operated by government, a Web site is a modern, fast moving business organization that demands quick decisions and strong leadership. City governments, on the contrary, move slowly, require public input for minor decisions, and require delays imposed by special rules relating to budgeting, dealing with vendors, etc.

Second, a relatively expensive department, such as the Web site department of a smaller city, will incur public resistance, even animosity, when local taxpayers compare it, its cost and effectiveness with another operated by another smaller city at no cost to the taxpayers because it is privately operated.

Third, an effective city Web site demands a highly effective CEO who devotes her/his entire attention to the success of the Web site. However, in a city government, the department head or elected official in charge of this operation may not have been elected because of business acumen or experience.

Fourth, the department head or elected official responsible for the operation of the city's Web site has numerous other responsibilities and may not be expected to give the Web site the highest priority.

Fifth, it is too easy for a department such as the community Web site to become a political football, so that it can easily become battered and bruised, thus destroying its effectiveness.

Sixth, since the Web site belongs to the taxpayers of the community, each of them will feel a right to dictate its policies, whereas an effective organization requires the motivation and singleness of purpose of any other successful business.

Seventh, even if the Web site is well supervised, normal government red tape will slow its actions making it difficult, if not impossible, for it to make a showing that will compare favorably with other small cities'Web sites that are privately owned and operated.

Eighth, too often, the policies of the city-operated Web site will be dictated by political expediency rather than the actual objectives of the site.

Ninth, as a business activity, the Web site must be free to deal freely and competitively with all businesses, something that is impossible in a political atmosphere, particularly in view of the need to conform to strict laws on budgeting, bidding, and otherwise dealing commercially with businesses and individuals.

Accordingly, there is a great demand for a method enabling smaller communities to quickly and inexpensively create an operating Web site.

### SUMMARY OF THE INVENTION

The object of this invention is to provide an improved method for communities to create a Web site.

We have invented a method for creating community Web sites. The method comprises: (a) creating a prototype Web site having general content and local content; and (b) providing a licensed Web site to a community, the licensed Web site sharing the general content with the prototype Web site and having local content that is specific to the community.

This method enables smaller communities to quickly and inexpensively create an operating Web site.

### BRIEF DESCRIPTION OF THE DRAWINGS

FIGS. 1 to 5 are pages from the prototype Web site of this invention.

### DETAILED DESCRIPTION OF THE INVENTION

A. Overview

The invention is a method to be used in providing various services to selected persons and organizations using the Web sites on the World Wide Web. In this method, a licenser who owns and operates a prototype Web site, for example www.QuincyNet.com, provides a complete Web site based on the prototype for a selected Licensee in a separate city. The licenser typically hosts the provided Web site on its computer. The provided Web site is adopted to the facts and conditions of the licensee's city. The licenser also provides the necessary training so that the licensee can begin immediate operation of the Web site from the Web site and, at the same time, conduct revenue operations to sustain the business profitably. The Web site thus provided is referred to as the licensed turnkey hometown community Web site.

B. Characteristics

There are several distinctive characteristics of the invention. Some of the more distinctive characteristics are as follows:

The licenser is a corporation that owns hometown community Web sites, and is prepared to enter into licensing agreements with local interests (the persons who will finance, create, and operate the business corporation that will maintain the Web site) in the smaller cities throughout America, and to assist them in the effective and profitable operation of such Web sites.

The licenser applies a list of criteria in the selection of the next city for the development of a licensed turnkey hometown community Web site. When that city is determined, the licenser prepares the hometown community Web site and begins its search for appropriate local interests.

The licenser is the owner and operator of the prototype hometown community Web site (www.QuincyNet.com), which contains (1) a large content of general information, links to many thousands of Web sites on all subjects, and other content that is of equal interest to all people in America, and (2) thorough coverage of local information, which is detailed information about every component of the community wherein the licensee is located.

The licensee is a business, normally a corporation, the purpose of which is to serve its community in various ways and, most particularly, to present an attractive showcase to the businesses of America, displaying every bit of pertinent information about their community in a way that is most conducive to attracting new businesses, branches, offices, plants and other extensions of their operations, that will bring good jobs and revenue to their community.

In addition, the licensee provides to all the people of their local community a portal to the World Wide Web. The portal is an attractive, carefully designed site that contains a vast array of information on countless subjects.

With the exception of special services to other businesses, such as the creation of Web pages, all the services and the content of every licensed turnkey hometown community Web site are free to all viewers. Their cost is supplied by the corporation that operates that Web site.

The licensee in each community is generally a for-profit corporation that has been created for this purpose by the local interests. It operates its licensed turnkey hometown community Web site as a platform to launch and operate various forms of revenue production.

The most important of the corporation's revenue streams is the providing to local businesses expert assistance in building and maintaining their own Web sites. Business models for other forms of revenue streams are complete and ready to be incorporated into each licensed turnkey hometown community Web site's business when it has sufficient trained staff to perform them proficiently.

The licenser also provides to all its licensees detailed plans for, and assistance in, the creation, implementation, and operation of other sources of revenue streams, which are to be incorporated into their operations as soon as they have mastered and are successful in operating their principal source of revenue, that is, the creation and maintenance of Web sites for local businesses.

The licenser prepares and places on line on a hometown community Web site designed specifically for the city and county where the licensee is located, with all the contents, general and local, complete and carefully designed to meet the needs and wishes of the people of that specific community.

While the hometown community Web site performs many functions, its most important is to serve as a showcase that tells the entire world what a good place it is to make a home, raise a family, run a business and, in all respects, enjoy the highest quality of life. Thus, it can serve as a community rallying point wherein enthusiasm for the community and concerted efforts to improve the community receive constant attention and publicity.

The licenser and the licensee enter into one or more agreements whereby the licenser makes it possible for the licensee to be fully prepared, on the very first day of business, to operate the licensed turnkey hometown community Web site, and to produce Web site services for local businesses, thus soon producing a profitable revenue flow. In the vernacular, they are able to “hit the ground running.”

The licensee pays to the licenser an annual fee which pays for all the rights herein described, for the licensee to use and operate the hometown community Web site, which rights are automatically renewable each year thereafter upon payment of the annual charge therefor.

The first group of rights given by such agreements includes the right to use all the features and general content of such Web site, together with all amendments, and supplements thereto, together with the right to use all the local content originally provided by the licenser, and the right to modify, supplement, and update all such local content, and the right to own all such local content that shall be newly created by the licensee.

The second group of rights given by such agreement to the licensee include the right to use an extensive supply of procedures and documents specifically designed for use by this specific hometown community Web site. Such documents include templates and other forms for the preparation and maintenance of Web sites for local businesses, organizational forms for the operation of the business, and forms and procedures for use in the marketing of the services offered by the licensee, both in the operation of the Web site and in the creation and operation of its revenue producing activities.

The third group of rights given by such agreement to the licensee is the right to instruction in the various procedures, methods, computer processes, and other actions required to implement and operate the various activities outlined above. This instruction consists of a combination of handson instruction, manuals, audio tapes, video tapes, computer disks, lectures, and all other procedures necessary to bring the entire staff of the licensee to the point where they are capable of operating every aspect of the business, on the very first day they are in business.

C. The Prototype Web Site

An example of the prototype for all licensed turnkey hometown community Web sites is the Web site located at www.QuincyNet.com. It is owned and operated by QuincyNet, a division of HCW Ltd., an Illinois corporation. The prototype Web site is managed and operated in the City of Quincy, Ill., and is in continuous development. It serves as the model and provides the basic content for all the licensed turnkey hometown community Web sites that will be established in conformity with licensing agreements with HSW Ltd.

The most significant fact about the licensed turnkey hometown community Web sites is that all of them will have, at all times, the identical features and content, with the exception of the local content which will always reflect facts and information about the organizations, activities, etc. as they appear in each of the respective communities in which the licensed turnkey hometown community Web sites operate. Therefore, the differences between general content and local content are highly significant and very important. Such differences must be kept distinctly in mind as one contemplates the exact nature of licensed turnkey hometown community Web sites.

D. Special Features Of The Prototype

One of the characteristics that makes the prototype (and therefore all licensed turnkey hometown community Web sites) truly unique is the fact that it is designed to meet the needs and wishes of two distinct groups: (1) the people who live in and near the selected city, and (2) those businesses all around the World that the local people are seeking to attract, to bring new business, jobs, and economic activity. As a result, everything about the construction and contents of the site are geared to satisfy the needs of those two audiences. It is assumed that most local viewers will have limited experience with the World Wide Web and will have the least sophisticated equipment. Every aspect of this Web site is prepared with those facts carefully considered. Accordingly, the site is architecturally designed for quick downloading, for easy navigation, and for the easiest, most direct ways of finding any desired information. It is also designed for family viewing, with each site bearing the SafeSurf seal, assuring that its content is suitable for viewing by people of all ages.

Licensed turnkey hometown community Web sites are equally notable and distinctive for what they do not contain. They do not contain large, unnecessary graphics, thus increasing the speed of downloading. They are largely devoid of banner ads, which only appear when necessary to incorporate a valuable service not otherwise available. Many do not contain any form of multi-media which, though glitzy, requires more sophisticated viewers and equipment.

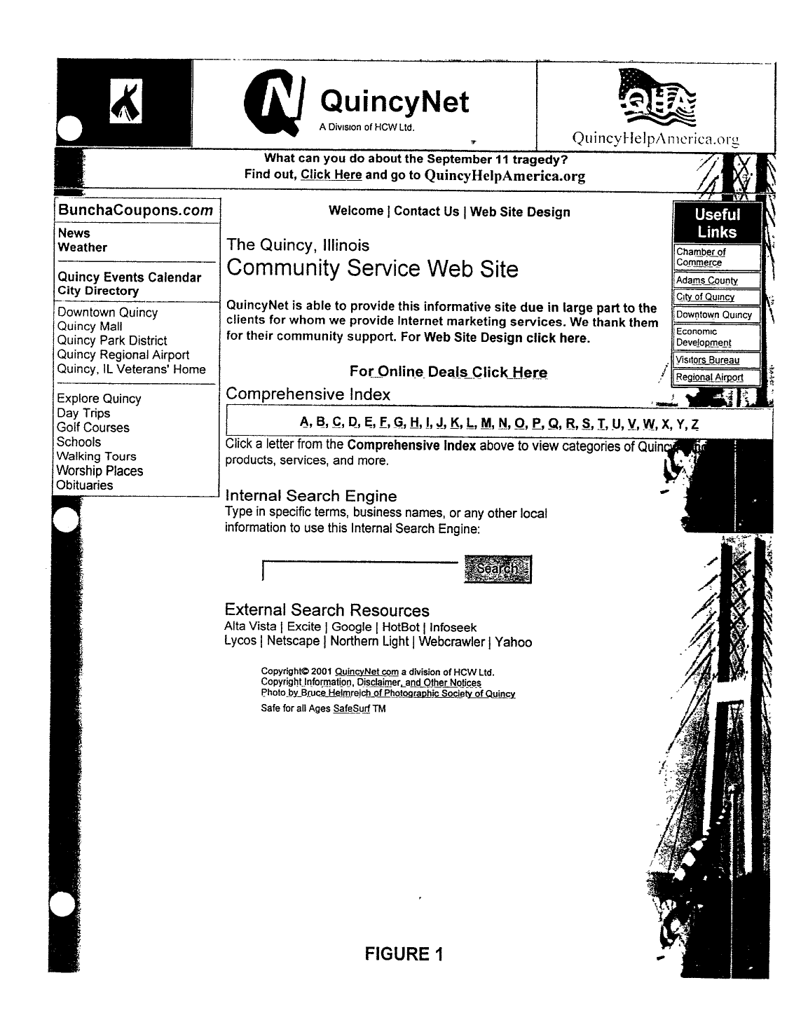

Turning now to the specific pages of the prototype www.QuincyNet.com Web site, FIG. 1 is the Home Page. The Home Page is an overview of the Web site, designed to tell the viewer what the site contains and its special features that aid in using the site. Links along the left side and along the top permit viewers to find preliminary information quickly. One of the links is to the Welcome page which tells the viewer about the people who prepare and maintain the site.

The Contact page contains information on contacting the publishers, as well as various notices about copyright and privacy. The Marketing page describes the services that are available from the publisher that will permit viewers to have their own Web site.

One of the important features of every licensed turnkey hometown community Web site is the Comprehensive Index. It appears on the Home Page and arranges alphabetically every subject covered in the site. That includes both general and local content. In many ways, this Comprehensive Index is a more than adequate substitute for the Dewey Decimal System. In effect, the viewer can get the “number” of the subject (by checking the subject's title) and then going to the stacks (clicking on that link) and immediately seeing all the “books” (linked sites) on the subject. The viewer is then free to “pull down” (click on any link) to browse the individual book on the subject.

Each viewer of www.QuincyNet.com and its progeny, the licensed turnkey hometown community Web sites, has immediate access to the content of the Web site itself and of all other sites on the World Wide Web. This remarkable capability results from the inclusion of both the standard search engines and a proprietary Internal Search Engine. It permits the viewer to type in the subject being sought. This engine instantly brings up all references to that subject that are included in both the general and the local content of our site. Without leaving this site, the viewer also has immediate access to all the major external search engines, such as Alta Vista, Excite, Google, HotBot, etc. As new, capable engines are introduced, they are examined carefully and, if found to be satisfactory, are added to those that the viewer can use to find nearly everything on the World Wide Web.

E. General Content Of The Prototype

The general content is the material found in all licensed turnkey hometown community Web site. At any moment in time, the general content of every such site is identical. The general content is constantly revised, updated, corrected and supplemented by the licenser. All such changes are made instantly on each licensed turnkey hometown community Web site.

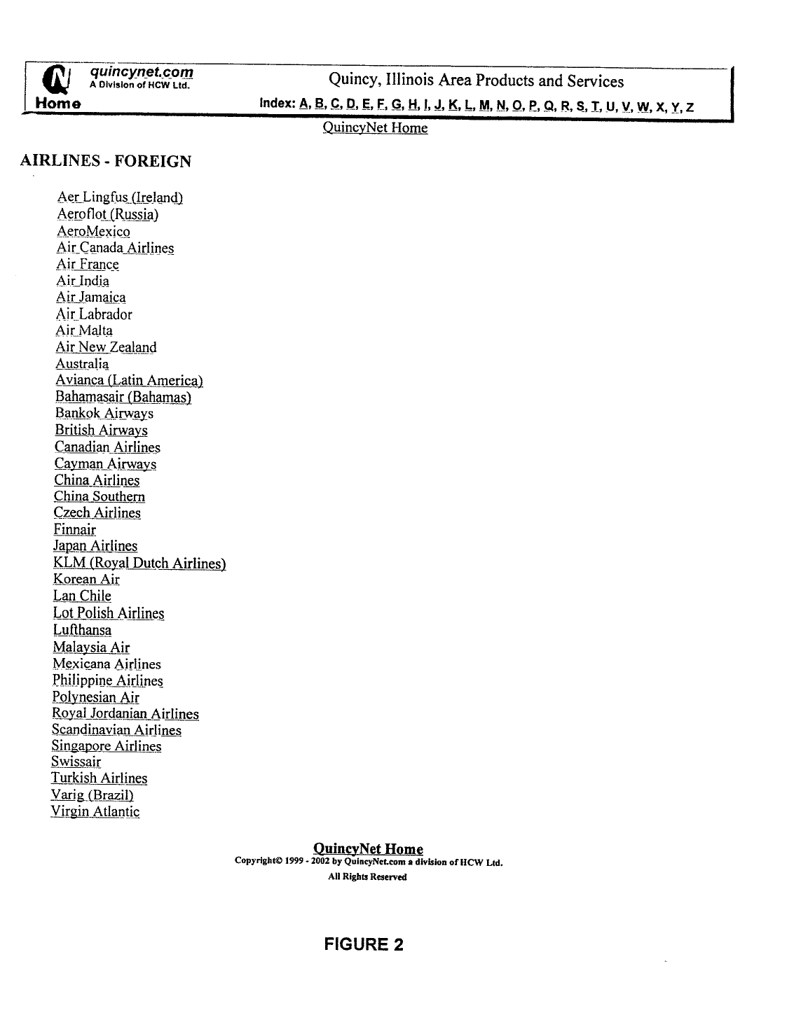

Most of the general content consists of a vast number of bookmarks (FIG. 2). There are thousands of topics on an extremely wide range of subjects. Each of these topics is linked to an AnaList, that is, a list of information about a particular subject. Each AnaList contains an average of 10 of the best Web sites on that subject. Some contain many more, if the subject is sufficiently popular.

There is a constantly ongoing process whereby staff members seek the best available sites, looking for good new sites, culling out the less satisfactory sites, eliminating broken links, and checking the remaining sites against a number of criteria, including, inter alia, their suitability for viewers of all ages. All bookmarks can be found quickly by viewers using either the Comprehensive Index or the internal search engine, both of which are always provided for every licensed turnkey hometown community Web site.

There is a separate section devoted to News. It is divided into principal categories, such as world news, sports, etc. A careful study is made as to the various sources of each of these types of news. In each case, the best has been selected, having in mind the needs of the viewers of the particular Web site. The news of general interest to viewers is about the same in one city as it is in another, but local and state news differs from city to city. Consequently, news is one of the categories that is largely general but is partially local.

This situation is also true with reference to the Weather page. In the prototype, as well as in all licensed turnkey hometown community Web sites, general weather over the state and nation are the same from city to city. Local weather, on the other hand, is highly individualized. Thus, weather is another category that is both local and general.

The federal government has an important impact on the life of every American. It has created a huge, comprehensive Web site that is linked to all federal Web sites, and answers virtually every question any viewer might have about the federal government and many other questions, such as health matters, that are of daily concern to every American. The prototype, www.QuincyNet.com, has incorporated the entire federal site in its own site. It is completely indexed as part of the Comprehensive Index, so that everything can be found very quickly. Links to federal government Web sites are distinctively marked. The same service is provided to every licensed turnkey hometown community Web site.

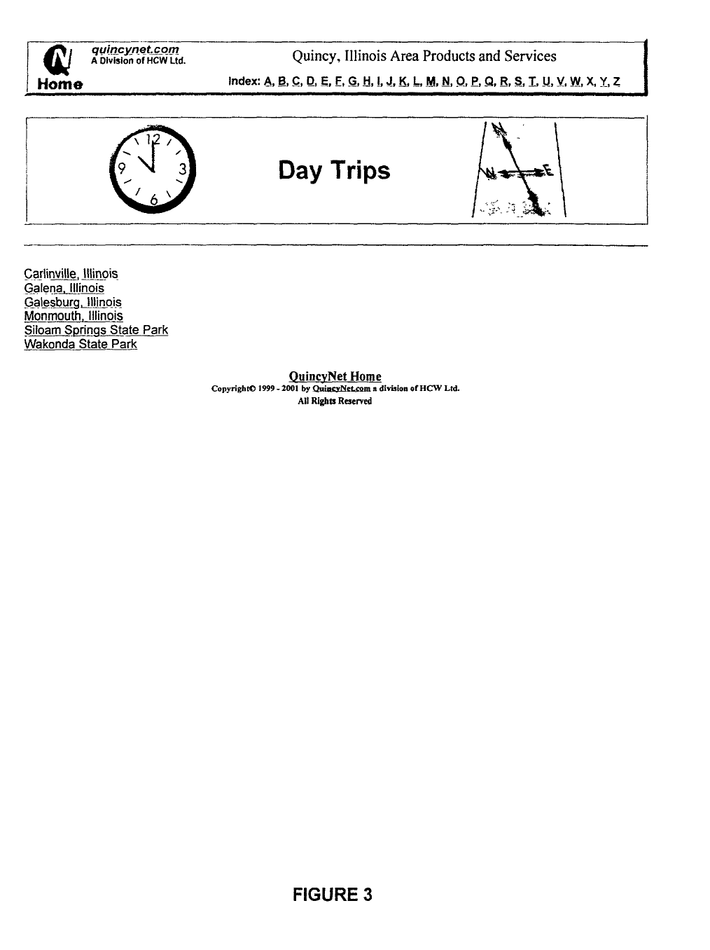

An unusual feature of the prototype, that is included in every licensed turnkey hometown community Web site, is the section designated Day Trips (FIG. 3). It is a collection of portrayals of numerous communities within a few hours drive of the city hosting the Web site. These day trips and weekenders are rich in information, pictures, places to stay and eat, as well as the local attractions that draw visitors. These are included in the general content. As the area that encompasses host cities expands, additional day trips will be included to give a complete choice of short vacation trips within easy driving distance.

F. Local Content Of The Prototype

After the licensed turnkey hometown community Web site has been turned over to the licensee, no further changes are made in the local content by the licenser. That becomes the task of the licensee who becomes the owner of such new content. What distinguishes licensed turnkey hometown community Web sites from all other Web sites is their rich content of information about every aspect of their home communities. This information must be gathered at considerable expense. Advertisers cannot justify such expense in the light of the comparatively small audience they can thus reach. As a result, it appears that no one has sought to fill this need until the establishment of the prototype, www.QuincyNet.com.

The prototype web site is located in a city of about 45,000 people, and thus is viewed as a small city. Yet, the backbone of much of America consists of much smaller cities, those with less than 10,000 people. It is about them that the invention is primarily concerned, in bringing Web sites that will fill so many of their Internet needs, as communities, as businesses, and as individuals.

Even the people in these smaller cities do not have more than a vague idea of the rich diversity of products and services, of every kind and description, that are available within a few blocks of their homes. It is for them that most of this vast array of information is provided. But, even more important to the economy of each community, this information is made available to every business in the world that could be looking for a suitable location for an office, a branch, terminal, etc. A careful study of the site will give any corporate executive a complete understanding and feeling for that community very quickly, thus avoiding unnecessary trips and expenses in looking into communities that might ultimately prove unsatisfactory and a waste of their time.

The Calendar of Events page lists all events in the entire community that their sponsors want known by the general public. They are carefully arranged in different ways so that the desired information can be found quickly.

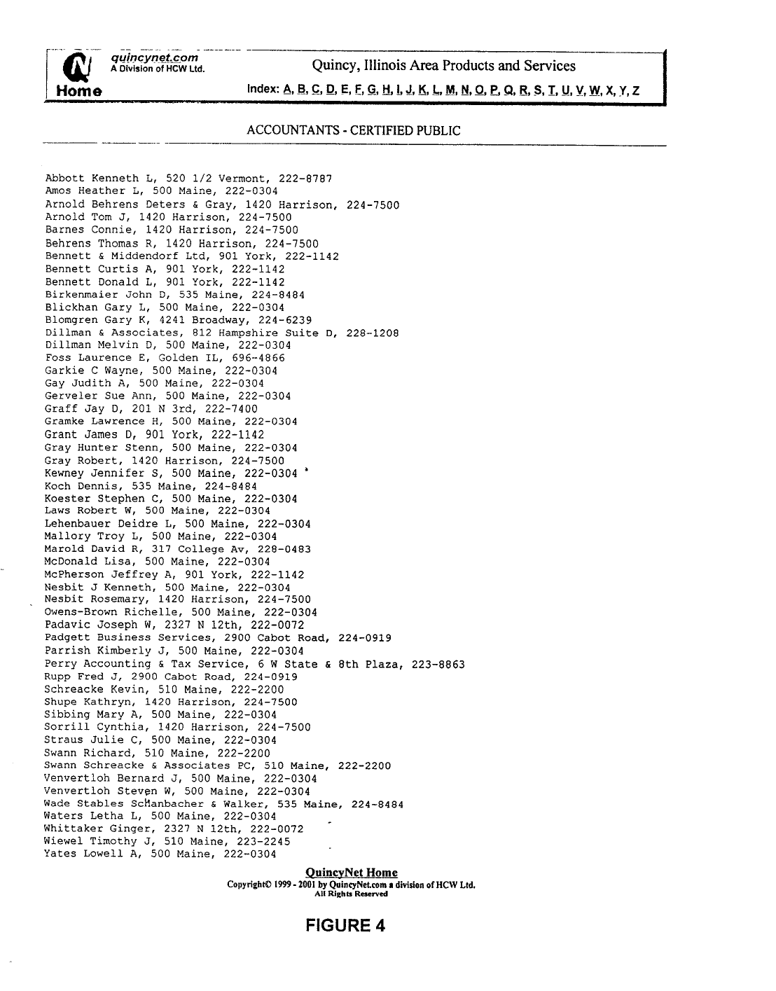

The Blue Pages (FIG. 4 are similar to the traditional Yellow Pages, but with significant differences. They do include the names, addresses, and telephone numbers of all businesses, government offices, and other resources in the community, as with the Yellow Pages. In addition, they are linked to the messages of many of the businesses of the community, so that they can give a lengthy message about their product(s)/services(s). In addition, like other web content, they are available 24 hours a day, 7 days a week, to everyone who has access to the web.

A large, complete Directory of Community Resources has been prepared for the home city of the prototype. A similar directory that relates to their own hometown is prepared, for inclusion in each licensed turnkey hometown community Web site. This directory is a complete list of all the health, education, recreational, and welfare resources and programs in the community. All such organizations are included whether they are public or private, profit or not-for-profit, governmental, volunteer, or charitable. It gives essential information about each of them. This information includes the names of personnel, the address, telephone number, URL, e-mail address, fax number, programs, eligibility requirements and any other information of general interest to the community. This directory is included in the local content of each licensed turnkey hometown community Web site. It is maintained and kept complete and current by its staff, with the cooperation of the organizations'personnel. This directory is not included as a separate figure, as it is not shown on the Web site as a separate document. Rather, the organizations contained in the directory are listed alphabetically in the Comprehensive Index. Viewers can also find them using the Internal Search Engine and the Blue Pages.

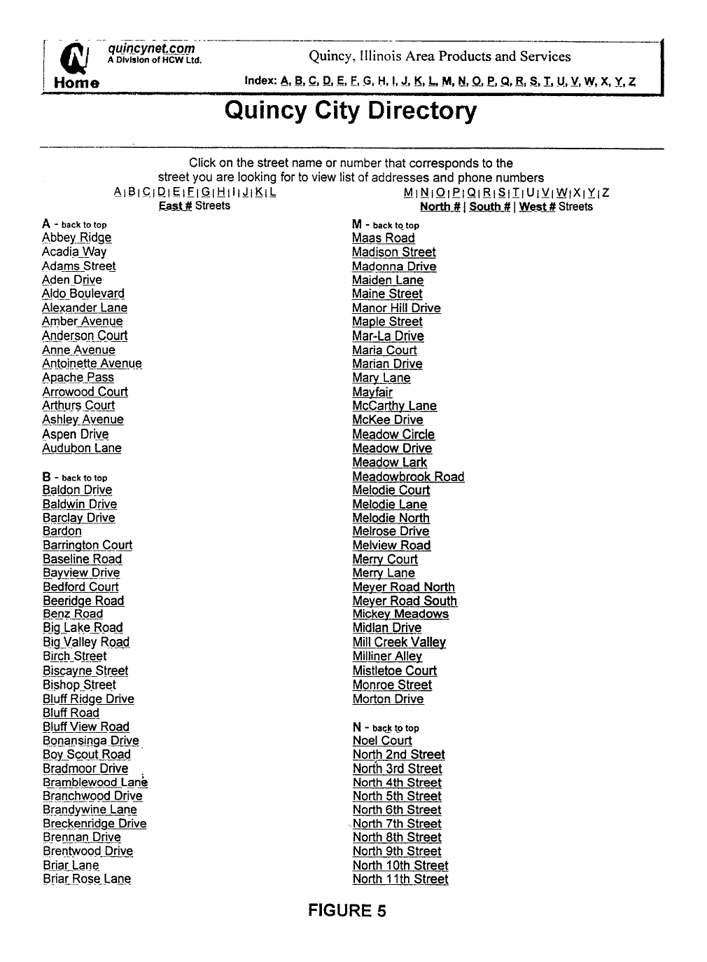

An important, and truly unique, part of every licensed turnkey hometown community Web site is a City Directory (FIG. 5) for the city that is its home. In addition, there may be city directories for each of the largest cities in the same county. This feature permits everyone, both local and far away, to get the name of the occupant and the telephone number for every address in the city. Also, the Internal Search Engine permits viewers to find a person's address or telephone number if only the person's name or telephone number is known. Links to web mapping sites permit viewers to get detailed maps of the community quickly and easily, without having to know any URLs to find such services, and without leaving the site.

Each such Web site also has a complete description of all the places of worship in the community. This includes information about personnel, special programs, times of services, masses, etc. Usually, these are accompanied by a picture of the place of worship. In addition, each Web site has a complete description of each of the parks in the community, together with pictures, lists of facilities available, special programs and events, and other information of interest to the people in the community. Each licensed turnkey hometown community Web site has a complete description of all the schools in the community, together with essential information about their personnel, programs, etc. In addition, special information such as athletic programs and lunch menus may be included as an additional public service.

Each smaller city has numerous homes and buildings that are of special interest because of their architecture, history, or former residents. These are combined into convenient walking tours. In addition to a map showing their location, there is a picture of each with an explanation of the architecture, the history of the building or its former occupant, etc. For many of its residents, one of the principal contributors to the quality of life is the proximity of a variety of golf courses. Most avid golfers think nothing of driving 100 miles or more for an interesting new challenge. Based on this, each licensed turnkey hometown community Web site contains a complete description of each golf course within 100 or so miles of the host city. Also included are facts about tee times, hole pars and distances, golf cart availability, instruction, etc.

Every city has special area attractions that are of interest to visitors and useful in drawing tourists. This may include state parks, preserves, museums, monuments, colleges, famous buildings, homes of famous people (the list is almost endless). For each of these local attractions that has its own Web site, there is a brief description with a link to its own Web site. If any such attraction does not have its own Web site, one is created for them and is hosted on the licensed turnkey hometown community Web site, without any cost to any of them.

G. Relationship Between The Licenser And Licensees

There are three distinct sets of relationships between the licenser and the licensee. The first set of relationships are those that exist during preliminary investigations by the parties, and negotiations between the parties, leading up to and including the execution of an initial agreement. The second set of relationships are those that exist from the date of the initial agreement until the date designated by the parties as “Opening Day,” the date selected for the completion of all necessary steps required for the operation of the licensed turnkey hometown community Web site in the licensee's city, and the commencement of the host of activities that constitute the operation of the business. The third set of relationships are those that exist between the parties from the Opening day and continuously thereafter until the termination of their contractual relationships. The latter set of relationships typically involve the hosting of the licensee's Web site by the licenser.

The relationships between the parties are defined by one or more written contracts. Since the subject matter of each of these areas is different from the others, they may be incorporated in three separate contracts, for ease in adopting the contractual relationships between the Licenser and the various Licensees in the different cities. However, all the relationships may also be covered by a single instrument. These relationships relate to several different areas that are quite distinctive from each other, but all are closely related as integral parts of a complex list of the rights and duties of each of the parties. For ease and clarity of understanding, these three sets of relationships can be considered separately, but it is essential to constantly consider how each of these relationships interacts with the others.

We claim:

1. A method for creating a community Web site, the method comprising:
(a) creating a prototype Web site having general content and local content; and
(b) providing a licensed Web site to a community, the licensed Web site sharing the general content with the prototype Web site and having local content that is specific to the community.

2. The method of claim 1 wherein information for the preparation and maintenance of Web sites for local businesses is provided with the licensed Web site.

3. The method of claim 2 wherein the prototype Web site includes a comprehensive index which arranges every subject covered in the site alphabetically.

4. The method of claim 3 wherein the prototype Web site includes a city directory which lists every address in the community along with the name of the occupant and the occupant's telephone number.

5. The method of claim 4 wherein the licensed Web site is hosted by the creator of the prototype Web site.
